(19) United States
(12) Patent Application Publication
(10) Pub. No.: US 2025/0104205 A1
(43) Pub. Date: Mar. 27, 2025

(54) METHOD AND SYSTEM FOR PROVIDING SPECIALIZED DOCUMENT SHARING PLATFORM

(71) Applicant: LG Management Development Institute Co., Ltd., Seoul (KR)

(72) Inventors: Jongsuk Kim, Seoul (KR); Janghyeon Lee, Seoul (KR); Hyounguk Shon, Daejeon (KR); Bumsoo Kim, Seoul (KR)

(21) Appl. No.: 18/949,410

(22) Filed: Nov. 15, 2024

Related U.S. Application Data
(63) Continuation of application No. PCT/KR2023/006577, filed on May 16, 2023.

(30) Foreign Application Priority Data
May 17, 2022 (KR) 10-2022-0059975
May 11, 2023 (KR) 10-2023-0061358

(51) Int. Cl. G06T 7/00; G06T 3/40; G06T 3/60

(52) U.S. Cl. CPC G06T 7/00; G06T 3/40; G06T 3/60; G06T 2207/20081

(57) ABSTRACT

An electronic device including a pretraining module, a loss application module, a score application module, the electronic device includes a memory, and a processor configured to provide a pretraining unified framework based on contrastive text image stored in the memory by controlling operations of the pretraining module, the loss application module, and the score application module, wherein the processor is configured to perform pretraining on a data set including at least one of text and images corresponding to a data set domain input through the pretraining module, apply a loss to a plurality of positive samples in the pretrained data set through the loss application module, and apply a score for embedding pretrained data sets from a plurality of domains in the same space based on a similarity through the score application module.

### CROSS REFERENCE TO RELATED APPLICATIONS

This application is a Bypass Continuation of International Patent Application No. PCT/KR2023/006577, filed on May 16, 2023, which claims priority from and the benefit of Korean Patent Application No. 10-2022-0059975, filed on May 17, 2022, and Korean Patent Application No. 10-2023-0061358, filed on May 11, 2023, each of which is hereby incorporated by reference for all purposes as if fully set forth herein.

### BACKGROUND

### Field

Embodiments of the invention relate generally to a method and system for providing specialized document sharing platform, and more specifically, to a method of providing a pretraining unified framework based on contrastive text-image and an electronic device using the same.

### Discussion of Background

Research on pretrained models has been conducted steadily. In particular, many self-supervision learning methods have been performed to pretrain models using unlabeled data sets and fine-tune downstream tasks to reduce labeling costs. In the past, these models were evaluated to have lower encoding capabilities than feature encoders in supervised learning models.

However, as computing power and data set sizes increase, new approaches can be attempted. In the field of text self-supervision learning, masking auto-encoding and auto-regressive generation techniques are mainly used, and in the case of image self-supervision learning, augmentation based contrastive learning is mainly performed.

The above information disclosed in this Background section is only for understanding of the background of the inventive concepts, and, therefore, it may contain information that does not constitute prior art.

### SUMMARY

Applicant recognized the problem that large-scale multi-modal representation learning such as CLIP consumes a lot of data. To overcome this problem, various studies have been proposed using additional losses due to other supervision. In general, SLIP learns image self-supervision together, and DeCLIP performs natural language supervised learning along with multi-view supervision, image self-supervision, text self-supervision, and nearest neighbor supervision.

For example, positive and negative pairs are focused on and provided only in the same area in order to calculate a contrast loss. That is, when a positive pair is text, a negative pair is composed of only text, and when the positive pair is an image, the negative pair is composed of only images.

Methods and systems for providing specialized document sharing platform according to embodiments of the invention are capable of overcoming the problem that large-scale multi-modal representation learning consumes a lot of data by utilizing augmentation aware function embedding. In general, SSL can be more powerful in image augmentation than VLP. This may be because some augmentations used only in SSL may break the alignment between image-text domains. Conversely, when only weak augmentations are used, training from an image-image domain may not be sufficiently performed. Between such trade-offs, embodiments of the invention utilize an architecture that includes an augmentation-agnostic image encoder and an augmentation aware projection head.

Additional features of the inventive concepts will be set forth in the description which follows, and in part will be apparent from the description, or may be learned by practice of the inventive concepts.

According to one or more embodiments of the invention, an electronic device including a pretraining module, a loss application module, a score application module, the electronic device includes a memory and a processor configured to provide a pretraining unified framework based on contrastive text image stored in the memory by controlling operations of the pretraining module, the loss application module, and the score application module, wherein the processor is configured to perform pretraining on a data set including at least one of text and images corresponding to a data set domain input through the pretraining module, apply a loss to a plurality of positive samples in the pretrained data set through the loss application module, and apply a score for embedding pretrained data sets from a plurality of domains in the same space based on a similarity through the score application module.

The processor may be configured to perform pretraining on the data set domain through the pretraining module based on an augmentation-agnostic image encoder and an augmentation-aware projection head.

The process may be configured to perform pretraining to which data augmentation is applied on a text domain, an image domain, and a text-image composite domain through the pretraining module, and the image domain may include a basic image domain, a first-stage augmentation image domain, and a second-stage augmentation image domain, which may be embedded in the same space.

The process may be configured to check whether data is augmented for the image domain, perform encoding for whether data is augmented checked through the augmentation-agnostic image encoder, and perform pretraining to correct a misalignment caused by the data augmentation through the augmentation-aware projection head based on the performed encoding, and the misalignment may be a misalignment with respect to a text domain due to data augmentation for the image domain.

The process may be configured to adjust balance of loss between the text domain and the image domain embedded in the same space through the loss application module.

The process may be configured to measure a similarity between data included in individual domains on the basis of different characteristics of the text domain and the image domain embedded in the same space through the score application module.

The process may be configured to apply a similarity score based on a first parameter and a second parameter for each text domain and each image domain through the score application module.

According to another embodiment of the invention, a method of providing a pretraining unified framework based on contrastive text-image, the method includes the steps of: performing pretraining on a data set including at least one of text and images corresponding to a data set domain input through a pretraining module, applying a loss to a plurality of positive samples in the pretrained data set through a loss application module, and applying a score for embedding pretrained data sets from a plurality of domains in the same space based on a similarity through a score application module.

According to still another embodiment of the invention, a chipset including a pretraining module, a loss application module, a score application module as at least one integrated circuit that implements different operations in association with a storage medium, the chipset for executing a method of providing a pretraining unified framework based on contrastive text-image, wherein the method includes the steps of: performing pretraining on a data set including at least one of text and images corresponding to a data set domain input through the pretraining module; applying a loss to a plurality of positive samples in the pretrained data set through the loss application module; and applying a score for embedding pretrained data sets from a plurality of domains in the same space based on a similarity through the score application module.

The at least one integrated circuit may include at least one of Programmable Gate Array (FPGA) and Application-Specific Integrated Circuit (ASIC).

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic block diagram of an electronic device to provide a unified framework according to an embodiment of the invention.

FIG. 2 is a schematic flowchart illustrating a method of providing a pretraining unified framework based on contrastive text-image according to an embodiment of the invention.

FIG. 3 is a diagram illustrating an example of pretraining based on contrastive text-image according to an embodiment of the invention.

FIG. 4 is a diagram illustrating an example of data augmentation of an image domain according to an embodiment of the invention.

FIG. 5 is a diagram illustrating an example of results of pretraining based on contrastive text-image according to an embodiment of the invention.

FIG. 6 is a diagram illustrating a process structure of a method of providing a unified framework according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the operation principle and embodiments of the invention will be described with reference to the attached drawings.

In the invention, a “device according to the embodiments of the invention” includes all of various devices that can perform computational processing and provide results to a user. For example, the device according to the embodiments of the invention may include all of a chipset, a computer, a server device, and a mobile terminal, or may be in the form of one of them.

Here, the chipset is a collection of integrated circuits, such as Field-Programmable Gate Arrays (FPGAs) or Application-Specific Integrated Circuits (ASICs), where one or more chips work together to perform specific tasks or enable system operations.

The computer may include, for example, a laptop computer, a desktop computer, a tablet PC, a slate PC, etc. equipped with a web browser.

The server device is a server that processes information by communicating with external devices, and may include an application server, a computing server, a database server, a file server, a game server, a mail server, a proxy server, and a web server.

The mobile terminal is, for example, a wireless communication device that ensures portability and mobility and may include all kinds of handheld-based wireless communication devices such as a personal communication system (PCS), global system for mobile communications (GSM), personal digital cellular (PDC), personal handyphone system (PHS), personal digital assistant (PDA), International Mobile Telecommunication (IMT)-2000, Code Division Multiple Access (CDMA)-2000, W-Code Division Multiple Access (W-CDMA), and Wireless Broadband Internet (WiBro) terminals, and a smart phone, and wearable devices such as watches, rings, bracelets, anklets, necklaces, glasses, contact lenses, and head-mounted devices (HMDs).

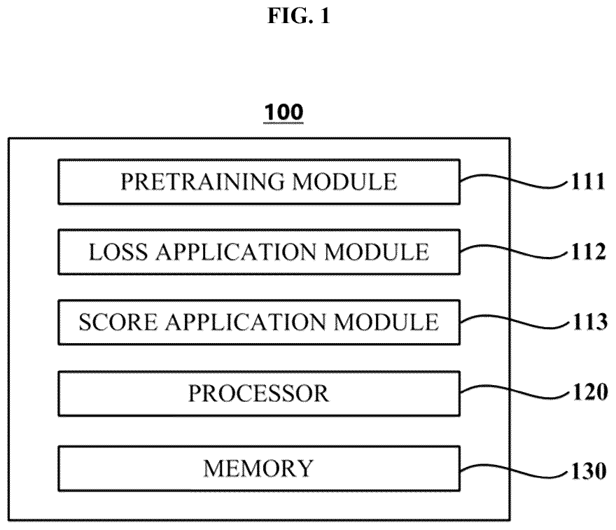

FIG. 1 is a schematic block diagram of an electronic device to provide a unified framework according to an embodiment of the invention.

Referring to FIG. 1, the electronic device 100 may include a kind of server that provides a pretraining unified framework based on contrastive text-image. The electronic device 100 may include a pretraining module 111, a loss application module 112, a score application module 113, a processor 120, and a memory 130 as internal components, but the embodiments of the invention is not limited thereto. Each node (i.e., each of the internal components 111, 112, 113, 120, and 130) may exchange data with other nodes. The nodes may be directly electrically connected or may be connected in a wired or wireless manner through a network. The electronic device 100 of the embodiments of the invention may perform the function of the processor 120 using a separate device instead of the processor 120.

Referring to FIG. 1, the processor 120 may control the operations of the pretraining module 111, the loss application module 112, and the score application module 113. The processor 120 may provide a unified framework through pretraining based on data acquired through a communication unit (not shown) or data previously stored in the memory 130.

The processor 120 according to the embodiment of the invention may be configured as the memory 130 that stores regarding an algorithm for controlling the operations of the components in the electronic device 100 or a program that reproduces the algorithm, and at least one function block that performs the aforementioned operations using the data stored in the memory 130. In this case, the processor 120 and the memory 130 may be configured as separate chips. Alternatively, the processor 120 and the memory 130 may be configured as a single chip.

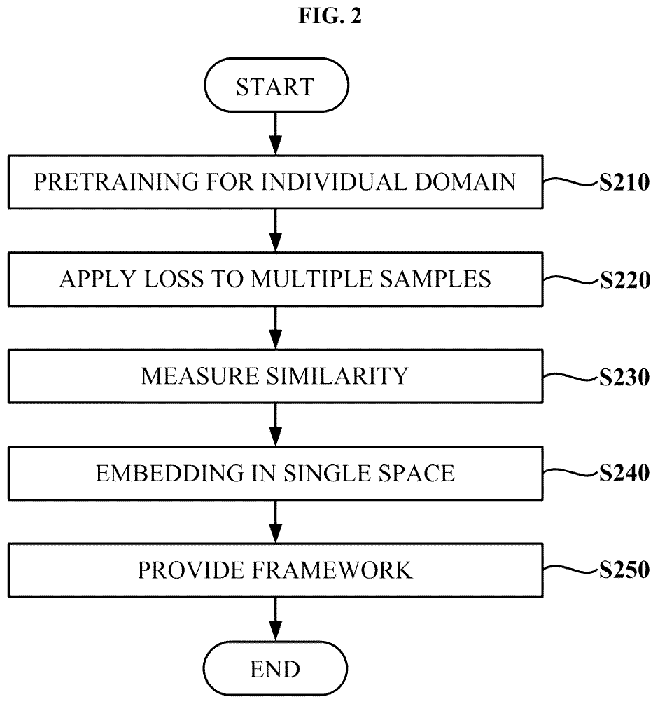

The processor 120 may control one or a combination of the components described above to implement various embodiments of the invention which will be described in FIG. 2 to FIG. 6 in the electronic device 100.

The memory 130 according to the embodiment may store data supporting various functions of the electronic device 100 and a program for the operation of the processor 120, input/output data (e.g., images, videos, etc.), a plurality of application programs (or applications) executed in the electronic device 100, data and instructions for the operation of the electronic device 100. At least some of such application programs may be downloaded from an external server through wireless communication.

The memory 130 may include at least one type of storage medium among a flash memory type, a hard disk type, a solid state disk (SSD) type, a silicon disk drive (SDD) type, a multimedia card micro type, a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. In addition, the memory may be a database that is separate from the electronic device 100 but connected thereto in a wired or wireless manner.

At least one component may be added or deleted in accordance with the performance of the internal components of the electronic device 100 illustrated in FIG. 1. In addition, it will be readily understood by those skilled in the art that the mutual positions of the components may be changed in accordance with the performance or structure of the device.

Meanwhile, each component illustrated in FIG. 1 is software and/or a hardware component such as a field programmable gate array (FPGA) and an application specific integrated circuit (ASIC).

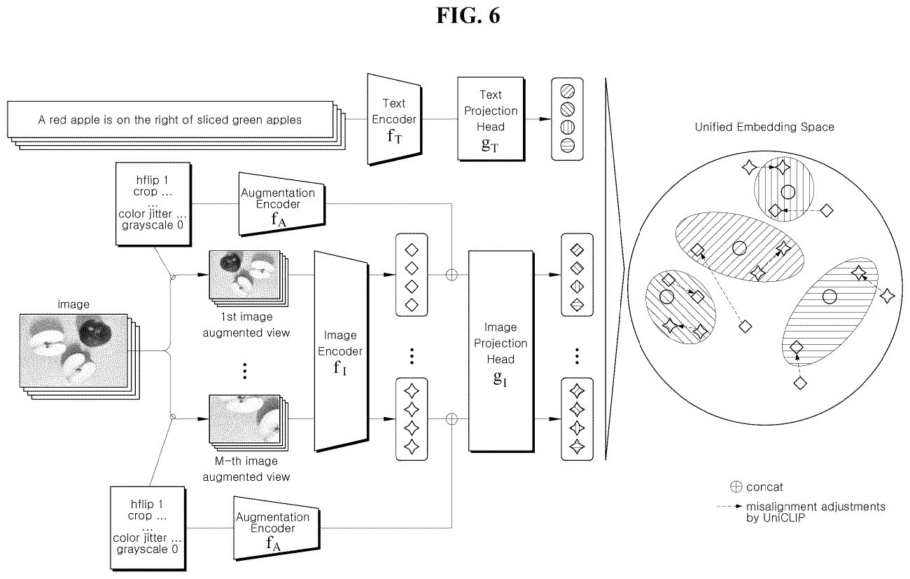

FIG. 2 is a schematic flowchart illustrating a method of providing a pretraining unified framework based on contrastive text-image according to an embodiment of the invention, and FIG. 6 is a diagram illustrating a process structure of a method of providing a unified framework according to an embodiment of the invention.

An electronic device (e.g., the electronic device 100 of FIG. 1) according to an embodiment may use a transformer-based architecture for both image and text encoders. For example, the electronic device may include an augmentation-agnostic image encoder. The electronic device may utilize the same training hyperparameter configuration. In addition, referring to FIG. 6, the electronic device may adopt a vision transformer using positional embeddings that can be learned with an image encoder f_{I}. In this case, an image representation h_{I} may be used as the last activation value of a token. Since the image encoder represents an input image domain without information on which data augmentation is applied, it can have a quality of representation sufficiently guaranteed by data augmentation.

According to an embodiment, as illustrated in FIG. 6, the electronic device includes an augmentation encoder. In order to use some data augmentation, parameters for individual data augmentation may need to be determined first. In this case, the electronic device can create an augmentation configuration a with such parameters and store the same including information on the type and degree of transformation to be applied to the relevant image. The augmentation configuration a is encoded using an augmentation encoder f_{A}, which is a 3-layer multilayer perceptron (3-layer MLP), and is transmitted to a projection head in the form of an augmentation token hₐ.

According to an embodiment, the electronic device may utilize random resized crop, color jittering, Gaussian blur, and horizontal flip & grayscale as augmentation and parameters thereof for pretraining.

For example, random resize crop may have preset lower and upper limits of a crop area and an aspect ratio. Within this range, the upper left coordinate of the crop area, the height, and the width of the crop area may be randomly determined. When an image is cropped using these values, the image size can be adjusted to 224×224. In addition, the upper left x, y coordinates, height, and width can be converted between 0 and 1 as a ratio to the overall image size. These values are included in the augmentation configuration and may include information on a certain part of the overall image.

Color jittering according to the embodiment can adjust four values of brightness, contrast, saturation, and hue of an image in a random order. The original image is returned when the first three values are 1 and the last three values are 0, and the names of these values can be defined as the original. Each value can be uniformly randomly determined within a predefined range according to the origin. In the case of augmentation encoding according to the embodiment, the difference from the original may be included in the augmentation configuration.

Gaussian blur according to the embodiment can be utilized by setting sigma to be used for the Gaussian kernel. The electronic device may perform random sampling within a predefined range and include the sampling result in augmentation configuration. Horizontal flip & grayscale according to the embodiment can operate without parameters. In this case, the electronic device may express whether or not it is applied as 1 or 0 and include the same in the augmentation configuration.

The electronic device according to an embodiment may include an augmentation-aware projection head. The augmentation-aware projection head may allow augmentation tokens and augmentation-agnostic image features to be included in a latent space. The augmentation-aware projection head may be trained to ignore augmentation effects of returning misaligned data within the same semantic boundary of the latent space. For example, a residual bottleneck block may be used in the augmentation-aware projection head gi instead of the widely used MLP. This may be because the augmentation-aware projection head needs to have sufficient encoding capabilities to encode augmentation information and image information at once. The residual bottleneck block may include two linear layers with GELU enabled. Here, layer normalization may be applied before the block and residual concatenation may be applied after the block.

The electronic device according to the embodiment may include a text encoder as illustrated in FIG. 6. The electronic device may utilize a transformer as a text backbone network with learnable positional embeddings. In this case, raw text can be tokenized with byte pair encoding (BPE) and wrapped with a start token and a last token. The text encoder f_{T} computes the output without an attention mask, and the last activation value of the start token can be used for text representation h_{T}. Here, a linear projection layer g_{T} may be embedded in the latent space. The architecture described in this way may be defined as the data embedding process below.

$${z}_{I} = {g}_{I} ( {h}_{I} , {h}_{a} ) = {g}_{I} ( {f}_{I} ( {x}_{a} , {e}_{I}^{p o s} ) , {f}_{A} ( a ) ) {z}_{T} = {g}_{T} ( {h}_{T} ) = {g}_{T} ( {f}_{T} ( {x}_{T} , {e}_{T}^{p o s} ) ) \qquad [ Mathematical expression 1 ]$$

In the mathematical expression 1, an augmented image xₐ=Aug(x_{I};a) can be defined by an arbitrary image x_{I}, an augmentation configuration a, and arbitrary text x_{T}.

Referring to FIG. 2, in step S210, a processor (e.g., the processor 120 of FIG. 1) may perform pretraining for an individual domain. Pretraining may be performed on a data set including at least one of text and an image corresponding to a data set domain input through a pretraining module (e.g., the pretraining module 111 of FIG. 1).

The electronic device according to the embodiment can unify contrastive learning, which has been independently utilized in different domains, into one framework to improve data efficiency. Accordingly, the unified framework provided by the electronic device of the embodiments of the invention can be referred to as unified framework for contrastive language-image pretraining (UniCLIP). The electronic device solves new problems in areas such as architecture, contrastive loss, and similarity score for the unified framework of contrastive learning, and extends existing contrastive learning. In addition, the effect of contrastive pretraining can be verified in image-text open data sets such as CC3M, CC12M, and YFCC15M, thereby achieving higher performance than the existing contrastive language-image pretraining (CLIP). The unified framework providing method of the embodiments of the invention can define contrastive learning of all pairs within and between multiple domains in a single unified embedding space.

The processor according to the embodiment can perform pretraining for the data set domain through the pretraining module based on the augmentation-agnostic image encoder and the augmentation-aware projection head. The processor may perform pretraining to which data augmentation has been applied on a text domain, an image domain, and a text-image composite domain through the pretraining module. Here, the image domain may be composed of a basic image domain, a first-stage augmentation image domain (e.g., weak augmentation image domain), and a second-stage augmentation image domain (e.g., strong augmentation image domain), and the processor can perform contrastive learning (e.g., pretraining) for all domain pairs between image domains, between image-text domains, and between text-text domains.

The processor according to the embodiment may check whether data augmentation is performed on the image domain and perform encoding for the checked data augmentation through the augmentation-agnostic image encoder. The processor performs pretraining to correct misalignment caused by the data augmentation through the augmentation-aware projection head based on the performed encoding, and the misalignment may be misalignment with respect to the text domain caused by the data augmentation for the image domain.

The processor according to the embodiment may encode information on what kind of data augmentation has been applied to the image domain through the augmentation-agnostic image encoder. This augmentation information is transmitted to the augmentation-aware projection head, and the augmentation-aware projection head may be pretrained to correct the misalignment caused by the data augmentation. Accordingly, the processor can prevent model training in which misalignment occurs from being damaged while sufficiently utilizing augmented data.

In step S220, the processor may apply a loss to a plurality of samples. The processor may apply a loss to multiple positive samples among pre-learned data sets through the loss application module (e.g., the loss application module 112 of FIG. 1). The processor may adjust the balance of loss between the text domain and the image domain embedded in the same space through the loss application module. Here, the processor may perform balance adjustment for all domain pairs such as text-image, image-image, and text-text domains.

In step S230, the processor may measure similarity. The processor may measure a similarity between data included in individual domains on the basis of different characteristics of the text domain and the image domain embedded in the same space through the score application module (e.g., the score application module 113 of FIG. 1). Accordingly, the processor may apply a similarity score based on parameters for the text domain and the image domain. In step S240, the processor may perform embedding in one space. In step S250, the processor may provide a unified framework.

According to the embodiment, a contrastive loss function can be classified according to the number of positive and negative pairs that a loss takes for one data point. For example, a triplet loss may take only a single positive pair and a single negative pair, an N-pair loss and the infoNCE loss may take a single positive pair and a plurality of negative pairs, and MIL-NCE loss and SupCon loss may take a plurality of positive pairs and a plurality of negative pairs. Since the unified framework of the embodiments of the invention has a plurality of positive pairs, the MIL-NCE loss and SupCon loss functions are checked first.

According to the embodiment, in the case of the i-th embedding zᵢ in embedding batch {zᵢ}ᵢ, Pᵢ may be assumed as a set of all positive sample indices of the i-th sample excluding i itself, and Ni may be assumed as a set of all negative sample indices of the i-th sample. This may be represented as the following mathematical expression 2.

$${P}_{i} = \{ j \vert ( {z}_{i} , {z}_{j} ) is a positive pair and j \neq i \} {N}_{i} = \{ j \vert ( {z}_{i} , {z}_{j} ) is a negative pair \} \qquad [ Mathematical expression 2 ]$$

According to the embodiment, the similarity score between i-th and j-th embeddings can be represented as s_{i,j}>0. The contrastive loss function can maximize the similarity score of positive pairs while minimizing the similarity score of negative pairs. If there is only one positive sample for each sample in the batch (e.g., Pᵢ={pᵢ}), infoNCE loss or NT-Xent loss for the i-th sample can be represented as the following mathematical expression 3.

$${ℒ}_{i}^{InfoNCE} = - log \frac{{s}_{i , {p}_{i}}}{{s}_{i , {p}_{i}} + {\sum }_{n ∈ {N}_{i}} {s}_{i , n}} \qquad [ Mathematical expression 3 ]$$

According to the embodiment, MIL-NCE loss for the i-th embedding can be represented as the following mathematical expression 4.

$${ℒ}_{i}^{MIL - N C E} = - log \frac{{\sum }_{p ∈ {P}_{i}} {s}_{i , p}}{{\sum }_{p ∈ {P}_{i}} {s}_{i , p} + {\sum }_{n ∈ {N}_{i}} {s}_{i , n}} \qquad [ Mathematical expression 4 ]$$

The MIL-NCE loss function of the mathematical expression 4 is configured to maximize the sum of similarity scores, Σ_{p∈P}_{ᵢ} s_{i,p}, of all positive pairs and minimize the sum of similarity scores, Σ_{n∈N}_{ᵢ} s_{i,n}, of all negative pairs. However, since the MIL-NCE loss compares negative pairs with positive scores Σ_{p∈P}_{ᵢ} s_{i,p} rather than each positive pair s_{i,p}, it cannot receive sufficient gradients from [symbol] ᵢ^{MIL-NCE} when there are easy positive pairs whose similarity scores are sufficiently large to dominate the scores of hard positive pairs and negative pairs. In some cases of q∈Pᵢ, the gradient from [symbol] ᵢ^{MIL-NCE} to s_{i,q} can be represented by the following mathematical expression 5.

$$\frac{\partial {ℒ}_{i}^{MIL - N C E}}{{\partial }_{{s}_{i , q}}} = - \frac{{\sum }_{n ∈ {N}_{i}} {s}_{i , n}}{\begin{matrix}( {\sum }_{p ∈ {P}_{i}} {s}_{i , p} ) \\ ( {\sum }_{p ∈ {P}_{i}} {s}_{i , p} + {\sum }_{n ∈ {N}_{i}} {s}_{i , n} )\end{matrix}} \qquad [ Mathematical expression 5 ]$$

In the mathematical expression 5, even if the score s_{i,1} of the positive pair is small, the gradient can be extinguished to 0 when Z_{p∈P}_{ᵢ} s_{i,p} is large due to easy positive pairs. Easy positive pairs hinder training of hard positive pairs in MIL-NCE loss, and this can be more prominent in the unified framework because hard positives and easy positives often coexist due to intra-domain and inter-domain supervision.

According to the embodiment, the SupCon loss for the i-th embedding can be represented as the following mathematical expression 6.

$${ℒ}_{i}^{S u p C o n} = - {𝔼}_{p ∈ {P}_{i}} [ log \frac{{s}_{i , p}}{{\sum }_{{p}^{′} ∈ {P}_{i}} {s}_{i , {p}^{′}} + {\sum }_{n ∈ {N}_{i}} {s}_{i , n}} ] \qquad [ Mathematical expression 6 ]$$

In the mathematical expression 6, each positive pair s_{i,p} is compared with a negative pair, but the sum of the positive scores in the denominator may still cause undesirable side effects. In the case of an easy positive pair with a large similarity scores, the loss can be reduced by decreasing the score and the denominator.

$$\frac{\partial {ℒ}_{i}^{SupCon}}{\partial {s}_{i , q}} = \frac{{s}_{i , q} - \frac{1}{\vert {P}_{i} \vert} ( {\sum }_{p ∈ {P}_{i}} {s}_{i , p} + {\sum }_{n ∈ {N}_{i}} {s}_{i , n} )}{{s}_{i , q} ( {\sum }_{p ∈ {P}_{i}} {s}_{i , q} + {\sum }_{n ∈ {N}_{i}} {s}_{i , n} )} \qquad [ Mathematical expression 7 ]$$

In the mathematical expression 7, in the case of q∈Pᵢ, hard positives can be trained better than the MIL-NCE loss due to relatively large update by the s_{i,q} term in the denominator. However, if it is assumed that the sum of the positive scores is much greater than the sum of the negative scores, it can be represented as the following mathematical expression 8.

$$\frac{\partial {ℒ}_{i}^{SupCon}}{\partial {s}_{i , q}} ∝ {s}_{i , q} - \frac{1}{\vert {P}_{i} \vert} ( {\sum }_{p ∈ {P}_{i}} {s}_{i , p} + {\sum }_{n ∈ {N}_{i}} {s}_{i , n} ) \approx {s}_{i , q} - {𝔼}_{p ∈ {P}_{i}} [ {s}_{i , p} ] \qquad [ Mathematical expression 8 ]$$

According to the embodiment, since the gradient is not always negative, [symbol] ᵢ^{SupCon} may try to reduce the positive score s_{i,q} instead of increasing the same if s_{i,q} is greater than the average positive score. That is, hard positive pairs can hinder convergence of easy positive scores in SupCon loss.

According to the embodiment, since the sum of positive scores in the denominator causes easy and hard positive pairs to interfere with each other, a multi-positive version of infoNCE loss can be used, as in the mathematical expressions 9 and 10 below, to allow individual positive pairs to contribute independently to the loss.

$${ℒ}_{i} = - {𝔼}_{p ∈ {P}_{i}} [ log \frac{{s}_{i , p}}{{s}_{i , p} + {\sum }_{n ∈ {N}_{i}} {s}_{i , n}} ] \qquad [ Mathematical expression 9 ]$$

$$\frac{\partial {ℒ}_{i}}{\partial {s}_{i , q}} = - \frac{{\sum }_{n ∈ {N}_{i}} {s}_{i , n}}{\vert {P}_{i} \vert {s}_{i , q} ( {s}_{i , q} + {\sum }_{n ∈ {N}_{i}} {s}_{i , n} )} \qquad [ Mathematical expression 10 ]$$

In the mathematical expression 10, hard positive sample can be sufficiently trained from a large update, and the problem of decreasing positive pair similarity may not occur. In this case, the following mathematical expression 11 can be used as a loss function.

$${ℒ}_{i}^{M P - N C E} = - {𝔼}_{p ∈ {P}_{i} ⋃ \{ i \}} [ {ω}_{i , p} log \frac{{s}_{i , p}}{{s}_{i , p} + {\sum }_{n ∈ {N}_{i}} {s}_{i , n}} ] \qquad [ Mathematical expression 11 ]$$

In the mathematical expression 11, w_{i,p} can serve to reflect inter-domain and intra-domain pairs in the loss with the same contribution based on the domain relationship of the input pair. In addition, by including the similarity score with itself in the loss, the effect of generating a reference point for temperature and offset training can be expected. Here, the temperature may be a first parameter, and the offset may be a second parameter. The processor may apply extended multi-positive NCE (MP-NCE) such that the infoNCE loss can be applied even in a situation in which a plurality of positive samples is present as in the mathematical expression 11, by providing UniCLIP. MP-NCE takes the average of infoNCE losses for individual positive pairs in the current batch, and the processor can outperform other contrastive losses (e.g., MIL-NCE loss, SupCon loss, etc.) by introducing the concept of w_{i,p}, a hyperparameter that can balance losses across domains.

According to the embodiment, when the temperature scaled cosine similarity is appropriately designed for contrastive learning, it can serve to control the penalty strength for negative samples that are hard for temperature. However, the unified framework according to the embodiment has a difference in that it processes various types of pairs at once. Therefore, it is necessary to utilize similarity measurement that can consider a difference in domain.

According to the embodiment, in contrastive learning, there may be a reference point for dividing positives and negatives. This can be utilized for hardness measuring because easy samples are farther away and hard samples are closer to the reference point. However, since all pairs have the same reference point, it may not be necessary to consider the reference point when only a single type of data pair is used. For example, even if an offset value is subtracted from a similarity score in consideration of the reference point, it can be ignored due to fractional reduction in the infoNCE loss (e.g., mathematical expression 3).

On the other hand, when data pairs of different types are used to calculate a loss, the similarity score may have to include the offset differently. In addition, this type may require different levels of control through a specified temperature. Therefore, it is necessary to design the similarity function to have various offset and temperature terms according to the domain relationship of the input pair. In addition, learnable parameters can be set such that a model can adjust appropriate values by itself. This can be represented as the following mathematical expression 12. The similarity score between two embeddings of existing contrastive learning do not have the concept of b_{D(i,j)} in the mathematical expression 12. The processor of the embodiments of the invention may set an appropriate range of scores differently for each domain by utilizing the fact that each domain has different characteristics in a situation in which data from a plurality of domains are embedded in the same space in UniCLIP. This can be referred to as a domain-dependent similarity score, and the processor can learn different appropriate temperatures and offsets for individual domains D through UniCLIP. Accordingly, since image-image, image-text, and text-text pairs exist in the framework, the processor of the embodiments of the invention can use three temperatures and offsets for learning.

$${s}_{i , j} = exp ( \frac{1}{{T}_{i , j}} ( \frac{{z}_{a}^{T} {z}_{b}}{‖ {z}_{a} ‖ ‖ {z}_{b} ‖} - {b}_{i , j} ) ) \qquad [ Mathematical expression 12 ]$$

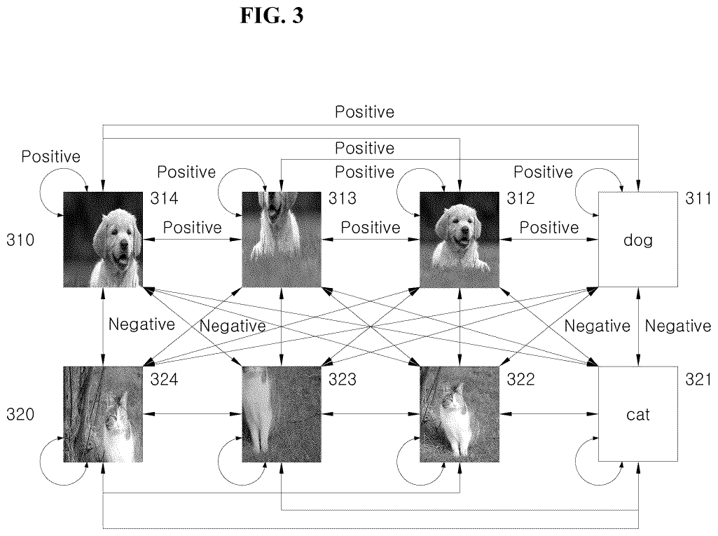

FIG. 3 is a diagram illustrating an example of pretraining based on contrastive text-image according to an embodiment of the invention.

Conventional frameworks augment the same image data through a self-supervision image feature learning method and use the same as a positive pair (e.g., simCLR, SSL). This is one of models used in contrastive learning, and can perform various downstream tasks by utilizing representation learned using image data. simCLR is composed of two main components, augments an input image through data augmentation, and enables a model to operate robustly in various environments. In addition, simCLR can perform learning in a way of maximizing a similarity between images and minimizing a similarity with other images using a contrast loss. This can be one of the methods that utilizes relatively strong augmentation.

For another example, CLIP is a pretraining method that learns an interaction between an image and text to perform various downstream tasks. CLIP allows an image and text to be compared in a single space, and accordingly the similarity between the image and the text can be measured. CLIP can perform pretraining using methods such as contrastive learning and self-supervision. In particular, it focuses on learning characteristics between an image and text, and can use a pair of an image and text corresponding thereto as a positive pair. However, if the image is greatly augmented, the domain relationship with the text changes significantly, and thus only relatively weak augmentation is possible.

As another example, SLIP can measure a similarity between images using representation learned using image data. This is a method using simCLR and CLIP together, and it is a simple combination of the two methods, and thus it does not cover all domain pairs, such as text-image, image-image, and text-text domains.

UniCLIP according to the embodiment can allow efficient learning of all pairs between all domains, which can be represented as an example in FIG. 3. For example, 310 and 320 may refer to domains in a unified framework provided by the electronic device (e.g., electronic device 100 of FIG. 1). Here, text domains include 311 for “dog” and 321 for “cat”, and image domains include 312, 313, and 314 related to “dog” and 322, 323, and 324 related to “cat”. The text domain 311 and the image domains 312, 313, 314 included in the domain 310 can be determined as positive pairs, and the same applies to the text domain 321 and the image domains 322, 323, and 324 included in the domain 320.

According to the embodiment, among the image domains of FIG. 3, the basic image domains may be 312 and 322. In this case, the first-stage augmentation image domain may correspond to 313 and 323, and the second-stage augmentation image domain may correspond to 314 and 324. The first-stage augmentation may be weak image augmentation (e.g., deformation), and the second-stage augmentation may be strong image augmentation, and the stages may be classified according to the degree of augmentation.

The processor according to the embodiment (e.g., the processor 120 of FIG. 1) may perform pretraining on a plurality of positive samples within and between all domains, as illustrated in FIG. 3. Accordingly, the processor can provide a more delicate and precise framework than the existing methods such as simCLR, CLIP, and SLIP.

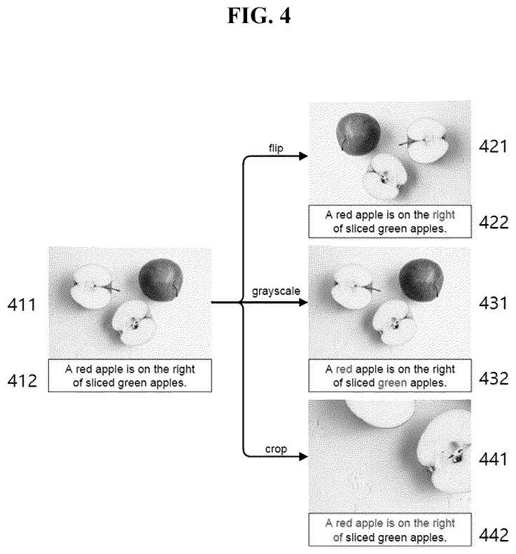

FIG. 4 is a diagram illustrating an example of data augmentation of an image domain according to an embodiment of the invention.

Referring to FIG. 4, it is possible to confirm image-text misalignment due to augmentation, which is a major problem that occurs in the process of designing contrastive learning between a plurality of domains in a single unified embedding space.

Referring to FIG. 4, the basic image domain may be 411 and the basic text domain may be 412. Image domains obtained by flipping, grayscaling, and cropping the basic image domain may be 421, 431, and 441. When data augmentation is performed on the basic image domain, the relationship with basic text domain can completely change. This can be confirmed by the fact that the basic text domain 412 has a misalignment in a bolded part (e.g., right) 422 in 421, a misalignment in a bolded part (e.g., red and green) 432 in 431, or a misalignment in a bolded part (e.g., A red apple is on the right of) 442 in 441.

According to the embodiment, the processor (e.g., the processor 120 of FIG. 1) can resolve such misalignment by reflecting information on image augmentation in embedding in the unified framework.

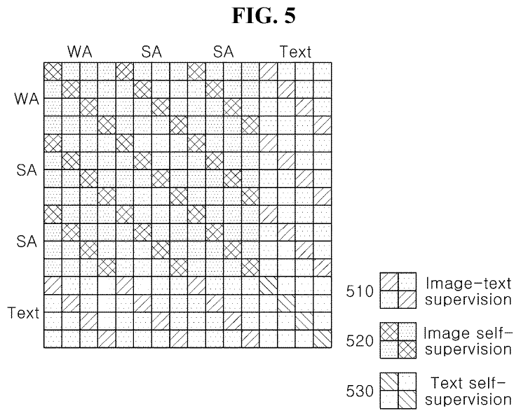

FIG. 5 is a diagram illustrating an example of results of pretraining based on contrastive text-to-image according to an embodiment of the invention.

FIG. 5 is a diagram illustrating an example of pretraining of a processor (e.g., the processor 120 of FIG. 1) for a plurality of domains. Referring to FIG. 5, weak augmentation (WA) may be a first-stage augmentation image domain, strong augmentation (SA) may be a second-stage augmentation image domain, and Text may be a text domain. In addition, a plurality of SAs be present by data augmenting the basic image domain in various manners.

According to the embodiment, the processor may perform pretraining between image and text domains, as in 510. In addition, the processor may perform pretraining between image and image domains and pretraining between text and text, as in 520. That is, the processor may perform pretraining in all given domains to provide a unified framework. FIG. 5 shows an example of performing pretraining to constitute a framework seamlessly in one embedding space.

Referring to FIG. 6, the electronic device according to the embodiment (e.g., the electronic device 100 of FIG. 1) may include an augmentation-aware projection head. The augmentation-aware projection head may allow augmentation tokens and augmentation-agnostic image features to be included in a latent space. The augmentation-aware projection head may be trained to ignore augmentation effects of returning misaligned data within the same semantic boundary of the latent space. For example, a residual bottleneck block may be used in the augmentation-aware projection head gi instead of the widely used MLP. This may be because the augmentation-aware projection head needs to have sufficient encoding capabilities to encode augmentation information and image information at once. The residual bottleneck block may include two linear layers with GELU enabled. Here, layer normalization may be applied before the block, and residual concatenation may be applied after the block.

The electronic device according to the embodiment may include a text encoder. The electronic device may utilize a transformer as a text backbone network with learnable positional embedding. Here, raw text may be tokenized with byte pair encoding (BPE) and wrapped with a start token and a last token to generate tokenized text x. Accordingly, a text representation h=f_{T}(x) and a text embedding z=g_{T}(f_{T}(x)) in a unified latent space can be obtained without augmentation embedding. A transformer may be used for the text encoder f_{T} with learnable positional embedding, and a linear layer may be used for a text projection head g_{T}. In this way, the last activation value of the start token may be used as the text representation h. That is, the text encoder f_{T} computes an output without an attention mask, and the last activation value of the start token may be used for the text representation h_{T}.

The processor according to the embodiment (e.g., the processor 120 of FIG. 1) encodes information on what kind of augmentation is applied to an image domain through an augmentation-agnostic image encoder, and performs embedding such that the augmentation information and image features pass through the augmentation-aware projection head and final embedding is achieved. In the structure as shown in FIG. 6, the processor can ascertain the augmentation information applied to the image through the augmentation-aware projection head, and the augmentation-aware projection head can correct the image-text misalignment problem caused by augmentation. This can be ascertained by referring to FIG. 6, where the information encoded through the augmentation-agnostic image encoder was blurry, but became bold with text after passing through the augmentation-aware projection head, and the information was combined with the results passing through the text encoder and the text projection head to be embedded in one space. Here, the blurry information may mean a state before augmentation, and the bold information may mean a state after augmentation. FIG. 6 shows text and an image embedded in one space through augmentation learning. Referring to FIG. 6, the electronic device of the embodiments of the invention can perform a process of correcting a misalignment with respect to text represented by each image in a single space to display more clear information. That is, the electronic device can perform a process of clearly expressing the correlation between text and an image in a single space through data augmentation.

According to various embodiments of the invention, it is possible to utilize the fact that data pairs in the same domain can be infinitely close through domain-dependent similarity measurement, but data pairs in different domains cannot be completely identical because the information representation method is essentially different.

In addition, according to various embodiments of the invention, due to such domain differences, negative image pairs can have higher similarity than difficult positive text pairs for images, and vice versa. Therefore, compensation for domain differences can be performed in order to compare data from multiple domains in one identical space. In the embodiments of the invention, learnable parameters are used for similarity measurement for compensating for domain differences, and a new MP-NCE loss function is proposed.

Recently, infoNCE loss has been used in SSL and VLP based contrastive learning, and has shown excellent performance. In the embodiments of the invention, it is extended to a multi-positive pair format to reduce mutual interference between easy positives and difficult positives. According to embodiments of the invention, a unified framework for contrastive text-image pretraining (UniCLIP) is proposed. In this case, a processor can train models by embedding various supervisions into a single space. This allows the processor to obtain a richer representational encoder through an independent supervision space. In addition, UniCLIP can increase the batch size while minimizing additional memory consumption by comparing all embeddings (data) across the domain. The UniCLIP of the embodiments of the invention can significantly outperform existing methods in various single- and multi-modal downstream tasks such as linear probing, fine-tuning, and image-text retrieval.

Meanwhile, the disclosed embodiments may be realized in the form of a recording medium storing instructions executable by a computer. The instructions may be stored in the form of program code, and when executed by a processor, may generate program modules to perform the operations of the disclosed embodiments. The recording medium may be realized as a computer-readable recording medium.

A computer-readable recording medium includes all types of recording media storing instructions that can be deciphered by a computer. For example, examples of the computer-readable recording medium include a read only memory (ROM), a random access memory (RAM), a magnetic tape, a magnetic disk, a flash memory, an optical data storage device, etc.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An electronic device including a pretraining module, a loss application module, a score application module, the electronic device comprising:
a memory; and
a processor configured to provide a pretraining unified framework based on contrastive text image stored in the memory by controlling operations of the pretraining module, the loss application module, and the score application module,
wherein the processor is configured to:
perform pretraining on a data set including at least one of text and images corresponding to a data set domain input through the pretraining module;
apply a loss to a plurality of positive samples in the pretrained data set through the loss application module; and
apply a score for embedding pretrained data sets from a plurality of domains in the same space based on a similarity through the score application module.

2. The electronic device of claim 1, wherein the processor is configured to perform pretraining on the data set domain through the pretraining module based on an augmentation-agnostic image encoder and an augmentation-aware projection head.

3. The electronic device of claim 2, wherein the processor is configured to perform pretraining to which data augmentation is applied on a text domain, an image domain, and a text-image composite domain through the pretraining module, and
wherein the image domain includes a basic image domain, a first-stage augmentation image domain, and a second-stage augmentation image domain, which are embedded in the same space.

4. The electronic device of claim 3, wherein the first-stage augmentation image domain and the second-stage augmented image domain are generated by applying different augmentation techniques,
wherein the augmentation techniques include at least one augmentation technique among brightness adjustment, contrast adjustment, rotation, scaling, and color distortion.

5. The electronic device of claim 4, wherein the processor is configured to:
perform pretraining such that data of the first-stage augmentation image domain is generated by image augmenting data of the basic image domain through a weak augmentation technique including brightness adjustment and contrast adjustment, and
perform pretraining such that data of the second-stage augmentation image domain is generated by image augmenting the data of the basic image domain through a strong augmentation technique including rotation, scaling, and color distortion.

6. The electronic device of claim 3, wherein the processor is configured to:
check whether data is augmented for the image domain,
perform encoding for whether data is augmented checked through the augmentation-agnostic image encoder, and
perform pretraining to correct a misalignment caused by the data augmentation through the augmentation-aware projection head based on the performed encoding,
wherein the misalignment is a misalignment with respect to a text domain due to data augmentation for the image domain.

7. The electronic device of claim 6, wherein the processor is configured to adjust balance of loss between the text domain and the image domain embedded in the same space through the loss application module.

8. The electronic device of claim 7, wherein the processor is configured to measure a similarity between data included in individual domains on the basis of different characteristics of the text domain and the image domain embedded in the same space through the score application module.

9. The electronic device of claim 8, wherein the processor is configured to apply a similarity score based on a first parameter and a second parameter for each text domain and each image domain through the score application module.

10. The electronic device of claim 7, wherein the loss application module is configured to learn weighting of a relative loss between multiple domains for loss balance adjustment,
wherein the weighting is learned in consideration of characteristic differences of various text and image domains.

11. A method of providing a pretraining unified framework based on contrastive text-image, the method comprising the steps of:
performing pretraining on a data set including at least one of text and images corresponding to a data set domain input through a pretraining module;
applying a loss to a plurality of positive samples in the pretrained data set through a loss application module; and
applying a score for embedding pretrained data sets from a plurality of domains in the same space based on a similarity through a score application module.

12. The method of claim 11, wherein the step of performing pretraining comprises a step of performing pretraining on the data set domain through the pretraining module based on an augmentation-agnostic image encoder and an augmentation-aware projection head.

13. The method of claim 12, wherein the step of performing pretraining comprises a step of performing pretraining to which data augmentation is applied on a text domain, an image domain, and a text-image composite domain through the pretraining module,
wherein the image domain includes a basic image domain, a first-stage augmentation image domain, and a second-stage augmentation image domain, which are embedded in the same space.

14. The method of claim 13, wherein the performing pretraining comprises the steps of:
checking whether data is augmented for the image domain;
performing encoding for whether data is augmented checked through the augmentation-agnostic image encoder; and
performing pretraining to correct a misalignment caused by the data augmentation through the augmentation-aware projection head based on the performed encoding,
wherein the misalignment is a misalignment with respect to a text domain due to data augmentation for the image domain.

15. The method of claim 14, wherein the step of applying a loss comprises a step of adjusting balance of loss between the text domain and the image domain embedded in the same space through the loss application module.

16. The method of claim 15, wherein the step of applying a score comprises a step of measuring a similarity between data included in individual domains on the basis of different characteristics of the text domain and the image domain embedded in the same space through the score application module.

17. The method of claim 16, wherein the step of applying a score comprises a step of applying a similarity score based on a first parameter and a second parameter for each text domain and each image domain through the score application module.

18. A chipset comprising a pretraining module, a loss application module, a score application module as at least one integrated circuit that implements different operations in association with a storage medium, the chipset for executing a method of providing a pretraining unified framework based on contrastive text-image, wherein the method comprises the steps of:
performing pretraining on a data set including at least one of text and images corresponding to a data set domain input through the pretraining module;
applying a loss to a plurality of positive samples in the pretrained data set through the loss application module; and
applying a score for embedding pretrained data sets from a plurality of domains in the same space based on a similarity through the score application module.

19. The chipset of claim 18, wherein the at least one integrated circuit comprises at least one of Programmable Gate Array (FPGA) and Application-Specific Integrated Circuit (ASIC).
